(19) United States
(12) Patent Application Publication
(10) Pub. No.: US 2009/0031081 A1
(43) Pub. Date: Jan. 29, 2009

(54) SYSTEM AND MODULE FOR MERGING ELECTRONIC AND PRINTED DATA

(75) Inventors: Victor S. Moore, Lake City, FL (US); Susan Wallenborn, Raleigh, NC (US); Neil A. Katz, Parkland, FL (US); Mark Pozefsky, Chapel Hill, NC (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/828,194

(22) Filed: Jul. 25, 2007

(51) Int. Cl. G06F 13/28

(52) U.S. Cl. 711/115; 711/E12.067

(57) ABSTRACT

A system for merging electronic and printed information is provided. The system includes a computing device having a visual display. Additionally, the system includes a handheld electronic memory device containing at least one information file with information corresponding to printed information that is presented on a separate physical medium. The memory device also includes a processing file comprising stored computer-readable instructions. The system further includes an electrical connector that is attached to the handheld electronic memory device. The electrical connector connects to the computing device having the visual display so that the at least one information file and the processing file are conveyed via the electrical connector to the computing device when the electrical connector is connected to the computing device.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention is related to the field of data processing and, more particularly, to storing and processing electronic data derived from or corresponding to selected printed information.

### BACKGROUND OF THE INVENTION

As the processing power and storage capabilities of computing device has increased, so too has the amount of printed material that is stored in electronic form. Current technology allows a computing device to electronically store and process the content of entire books, for example.

Many readers and users of printed information, however, still prefer to be able in at least some instances to obtain information from printed books and to see the information in print, on paper. Regardless of the ease in viewing information on the printed page, conventional books and other printed publications can present a reader with certain inconveniences. For example, it can be difficult to flip back and forth between different pages. Similarly, for example, quickly identifying specific sought-after information in a book, such as a textbook, requires a reader to merely skim over one or more pages, thus increasing the risk that the desired information will be missed.

These difficulties are largely obviated by accessing information electronically, but as already noted this deprives the reader of the opportunity of seeing the information on a printed page. As yet there is no mechanism or technique for merging electronic and printed information so as to enjoy the efficiencies and convenience of electronic mediums with the readability of seeing information firsthand on a printed page.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system that includes a module for merging electronic and printed information according to one embodiment of the invention.

FIG. 2 is a schematic view of a system that includes a module for merging electronic and printed information according to another embodiment of the invention.

FIG. 3 is a schematic view of an apparatus for electronically annotating merged printed and electronic information, according to still another embodiment of the invention.

FIG. 4 is a schematic view of an apparatus for electronically annotating merged printed and electronic information, according to yet another embodiment of the invention.

FIG. 5 is a flowchart of exemplary steps in a method for merging electronic and printed information, according yet another embodiment of the invention.

### DETAILED DESCRIPTION

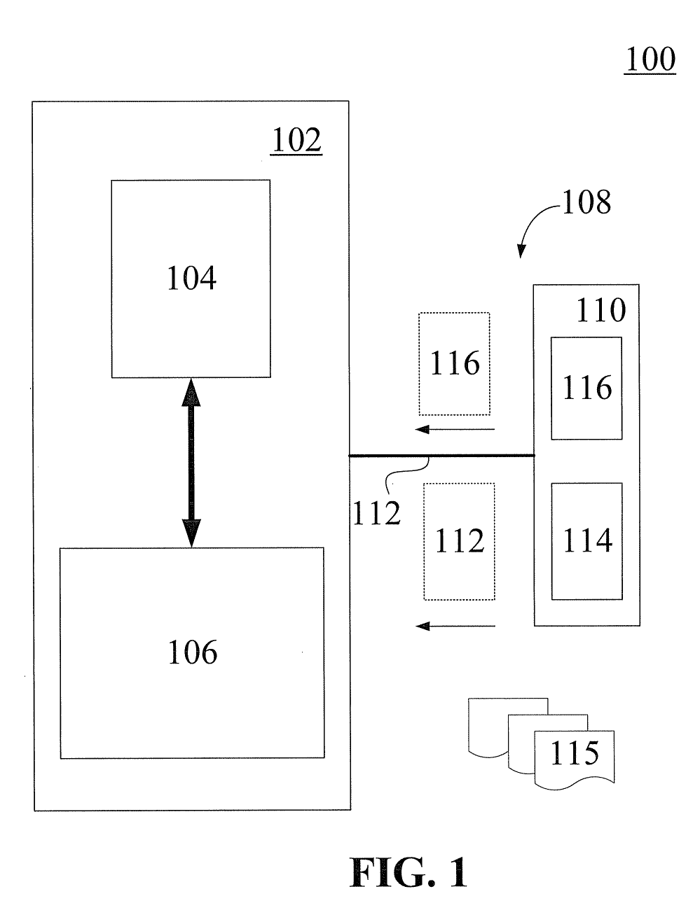

FIG. 1 is a schematic view of a system 100 according to one embodiment of the invention. The system 100 illustratively includes a computing device 102 having a processor 104 and a visual display 106. The system 100 also illustratively includes an electronic module 108 for merging electronic and printed information. The term merging is used herein in the general sense of enabling one to access the same information in both a printed and electronic form.

The electronic module 108, more particularly, includes a handheld electronic memory device 110 and an electrical connector 112 connected to the handheld electronic memory device. The handheld electronic memory device 110 can be, for example, a small-sized read-only memory (ROM) device. Accordingly, the size and shape of the handheld electronic memory device 110 is preferably comparable to that of the so-called keychain Universal Serial Bus (USB) Memory Card, as will be readily understood by one of ordinary skill in the art. The small size of the handheld electronic memory device 110 permits the device to be removably attached to an object containing printed information, such as a book. Alternately, the handheld electronic memory device 110 can be embedded in an object containing printed information, such as a book. For example, the handheld electronic memory device 110 can be embedded in the binder of a book.

The handheld electronic memory device 110 contains at least one information file 114. The information file 114 comprises information corresponding to that printed on a physical medium such as the pages 115 of a book. The information contained in the information file 114 need not be identical to that appearing in printed form on a physical medium such as the pages 115 of a book. Instead, the information in one form can enhance or embellish the information in the other form. For example, the information file 114 can comprise, in addition to text corresponding to that appearing on the pages 115 of a book, hyperlinks that are not otherwise provided on the actual pages of the book. The information file 114 can comprise, for example, code that creates a virtual storybook world corresponding to the textual content of the book. These and other enhancements that can be contained in the information file 114 for enriching the experience of one reading printed textual material on the pages 115 of a book are described more particularly below.

The information file 114 can have various file formats. Indeed, for conveying textual information corresponding to the pages of a book, such as an academic textbook, the information file 114 can have any file format. For example, the information file 114 can be a PDF or CHN file that contains the contents of a book. Moreover, the information file 114, independent of the particular format, can be a protected file to prevent copying; that is, the files can be encrypted and thus accessible only through the electronic module 108.

Additionally, the handheld electronic memory device 110 contains a processing file 116. The processing file 116 contains computer-readable code for directing operations performed by the computing device 102 when downloaded to the computing device. For example, the processing file can be an AUTO-RUN file that causes the processor 104 of the computing device 112 to display the contents of a book, stored in the handheld electronic memory device 110, as a PDF or CHN file, for example, on the visual display 104. Various other operative functions that the processing file 116 can cause the computing device 102 to perform are described more particularly below.

The module 108 additionally includes an electrical connector 118 attached to the handheld electronic memory device 110. For example, the electrical connector 118 can be a flexible, low-profile USB cord that extends from the handheld electronic memory device and has a plug (not shown), such as a USB series “A” plug, configured to plug into a USB port (also not shown) of the computing device 102. The electrical connector 118 can provide an appropriate electronic interface through which the information file 112 and the processing file 116 can be electronically conveyed to the computing device 102. As illustrated, the electrical connector 118 extends outwardly from the handheld electronic memory device 110. This configuration of the electrical connector 118 allows the module 108 to communicatively link to the computing device 102 while the module is embedded in an object, such as a book.

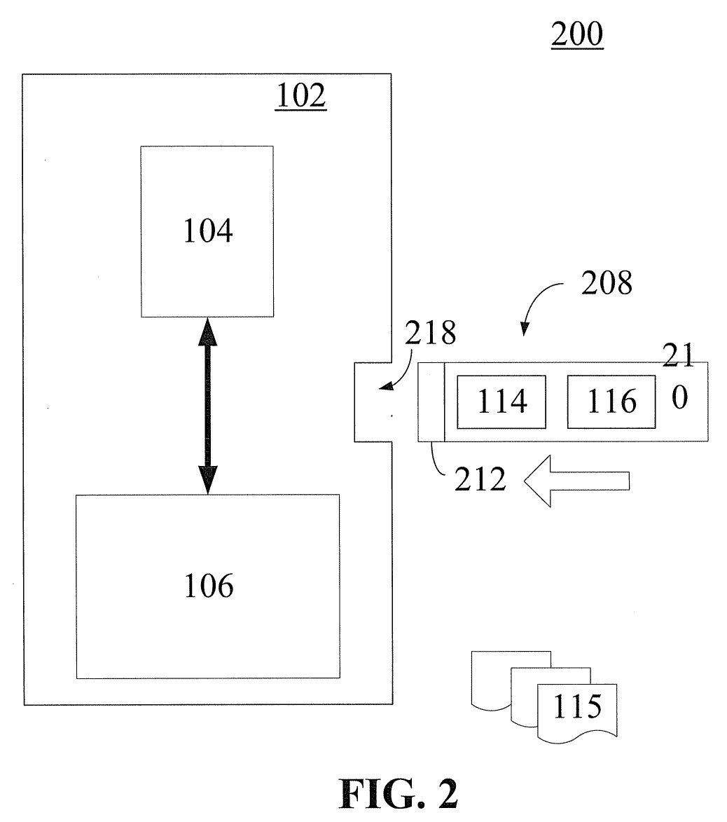

FIG. 2 is a schematic view of a system 200 according to another embodiment of the invention. As shown, the system 200 includes a module 208 for merging electronic and printed information. The electronic module 208, according to this embodiment, also comprises a handheld electronic memory device 210 and an electrical connector 212 communicatively linked to the handheld electronic memory device. According to this particular embodiment, the form factor of the handheld electronic memory device 208 is that of a keychain memory device, such as a keychain USB memory device. Further according to this embodiment, the electrical connector 210 is configured to plug directly into a port 218 of the computing device 102. The electrical connector 210 can be, for example, a USB connector, and the port 218 can be a USB port, as will be readily understood by one of ordinary skill in the art.

Different operative features of a module 108, 208, according to the invention, are now described with reference to both FIG. 1 and FIG. 2. According to one embodiment, the processing file 116 conveyed to the computing device 102 from a handheld electronic memory device 110, 210 through an electrical connector 112, 212 comprises stored computer-readable instructions. The computer-readable instructions cause the processor 104 of the computing device 102 to search the information file 114 for user-selected portions of the printed information contained therein. The processing file 116, according to this embodiment, further comprises stored computer-readable instructions for causing the processor 104 to display the user-selected portions of printed information on the visual display 106 of the computing device 102.

If the printed information contained in the information file 114 is the text of a book, for example, a user is able to read text from the pages of the book while also being able to search for specific words, phrases, or passages without having to leaf through the pages of the book. In a particular embodiment, a handheld electronic memory device 110, 210 comprises both ROM and random access memory (RAM). The text of the book, in electronic form, is stored as the information file 114 in the ROM, whereas computer-readable instructions are stored as the processing file 116 in the RAM. When the stored instructions are conveyed to the processor 104 of the computing device 102, the instructions cause the processor to search the information file 114 for user-specified words, phrases, or passages.

According to one embodiment, the stored instructions include computer-readable instructions for causing the processor 104 to search for words, phrases, or passages in response to a user's typing words or characters on a keyboard (not shown) communicatively linked to the computing device 102. In another embodiment, the stored instructions include computer-readable instructions that cause the processor 104 to generate on the visual display 106 a glossary or index whose elements a user can select by moving a cursor over the display using a keyboard or computer “mouse,” for example.

In another embodiment, the stored instructions contained in the processing file 116 comprise computer-readable instructions for causing the processor 104 of the computing device 102 to convey update information to a handheld electronic memory device 110, 210 via an electrical connector 112, 212. Moreover, according to this embodiment, the stored instructions comprise computer-readable instructions for causing the processor 104 to store the update information. The update information can be stored in a memory (not shown) of the computing device 102 and/or in RAM in the handheld electronic memory device 110, 210.

More particularly, the update information can be initially supplied to the computing device 102 by a system user through a user-interface (not shown) of the computing device, such as a conventional keyboard or computer mouse. For example, if the printed information contained in the information file 114 is the text of a book, a user is able to add user-specified notes to the information file 114 by supplying the notes to the computing device 102 through the user interface. According to another aspect of the invention, because user-generated notes and annotations can be electronically stored, notes and annotations made by one reader of a book can be shared with another reader of the book by uploading and downloading stored notes. In the specific context of notes electronically added to an academic textbook, for example, notes added by one student can be shared with another in this manner, resulting in a value-added service that a book publisher can provide to a book owner.

According to a particular embodiment, the stored instructions contained in the processing file 116 comprise computer-readable instructions for causing the processor 104 to display a user-selected page of text on the visual display 106. Using a keyboard and/or mouse, the user can move a cursor to a desired location on the displayed page of text, either in a margin or over the text itself. The user can then add the notes at the desired location by typing in the notes using the keyboard. In a similar manner, a user can annotate selected portions of the text. One advantage is that the user is able to add comprehensive notes and/or extensively annotate portions of text to the information file 114 without actually marking the actual pages of text. The notes and annotations once stored remain in the information file 114. In any subsequent session, the notes and annotations can be displayed concurrently with corresponding portions of text, but the actual pages of the book remain unmarked. Notes and annotations can be saved to a memory (not shown) of the computing device 102 and/or in RAM in the handheld electronic memory device 110.

An object containing printed information, such as resalable textbook or instruction manual, typically has a higher resale value when the textbook or manual is unmarked. Economic theory as well as common sense suggest that, all else constant, raising the expected resale value of a product increases initial buyers' demand for the product. Thus, one possible advantage afforded by this aspect of the invention is that it may increase the value of certain classes of books, such as academic textbooks and instruction manuals.

In an alternative embodiment, update information for updating the information file 114 can be provided by a third-party entity, such as the publisher of a book which is distributed either with an electronic module 108 for merging electronic and printed information embedded in the book or with an electronic module 208 for merging electronic and printed information removably attached to the book. For example, if the book is one which is periodically revised, such as an academic textbook, the useful life of the physical book itself can be extended if the information file 114 is updated to include subsequent revisions to the textual material of the book. If the textbook was initially distributed with the electronic module 208 removably attached thereto, then the publisher can, for example, distribute a new electronic module having an information file that incorporates the most recent revisions to the text.

According to an alternate embodiment, if the textbook was initially distributed with the electronic module 208 embedded therein, the update information can first be downloaded to the computing device 102 and subsequently conveyed through the electrical connector 212 to the handheld electronic memory device 210 In one particular embodiment, the update information can be obtained from a remotely-located server or other computing device communicatively linked to the computing device 102 through a data communications network. According to this embodiment, the processing file 116 can include stored computer-readable instructions for causing the processor 104 of the computing device 102 to display an identifier on the visual display 106. The stored computer-readable instructions, according to this embodiment, further comprise instructions for causing the processor 104 to access the remotely located computing device over the data communications network in response to a user selecting the identifier.

Optionally, according to this embodiment, the stored computer-readable instructions also can include instruction for causing the processor 104 of the computing device 102 to receive from the at least one remotely-located computing device through the data communications network a request for user information. This affords a publisher of books, for example, the opportunity to maintain contact with individuals that purchase the publishers books. When a particular reader access the remotely-located computing device to obtain update information, or when the reader access other content through embedded links within the text, the publisher has the opportunity to offer for sale related books and products. This aspect of the invention also affords the publisher an opportunity to solicit information from the reader as well as present information. Accordingly, the processing file 116 can optionally store computer-readable instructions for causing the processor 104 to convey via a data communications network to the remotely-located computing device user responses to a request for information. In this manner, the publisher can obtain information from the reader that helps the publisher ascertain which books and products are of particular interest to the specific reader. The publisher also can charge the reader for further electronic enhancements to a physical book the reader has purchased in the past.

According to still another embodiment of the invention, the information file 114 or a separate file stored in the handheld electronic memory device 110, 210 further comprises supplemental information that supplements or embellishes the printed information. For example, if the object containing printed information is a textbook, the supplemental information can include working examples. The processing file 116 thus can optionally store computer-readable instructions for causing the processor 104 to access and execute the working examples on the visual display 106 of the computing device. Similarly, if the object containing printed information is a computer instruction manual, the supplemental information can include exemplary programs, and the processing file 116 can optionally store computer-readable instructions for causing the processor 104 to access and execute the exemplary programs.

According to yet another embodiment, the information file 114 can include, for example, one or more universal resource locators (URLs), can be electronically displayed along with displayed text but which do not appear in the printed text on the page of an actual book. Accordingly, the processing file 116 can optionally store computer-readable instructions for causing the processor 104 to access network-connected sites using the one or more URLs. The stored computer-readable instructions can further cause the processor 104 to access such a site in order to download corrections to textual material and/or update the textual material.

Supplemental information contained the information file 114 or a separate file in the handheld or embedded electronic memory device 110, 210 can alternately, or additionally include, role-playing or other types of games designed to enrich the experience of one reading printed textual material. Other supplemental information can include data that when conveyed to the processor 104 result in pictures or other graphics that can be viewed on the visual display 106, such as three-dimensional views of locations or enactments of events described by the textual material. In this manner, a reader can become part of a story, for example.

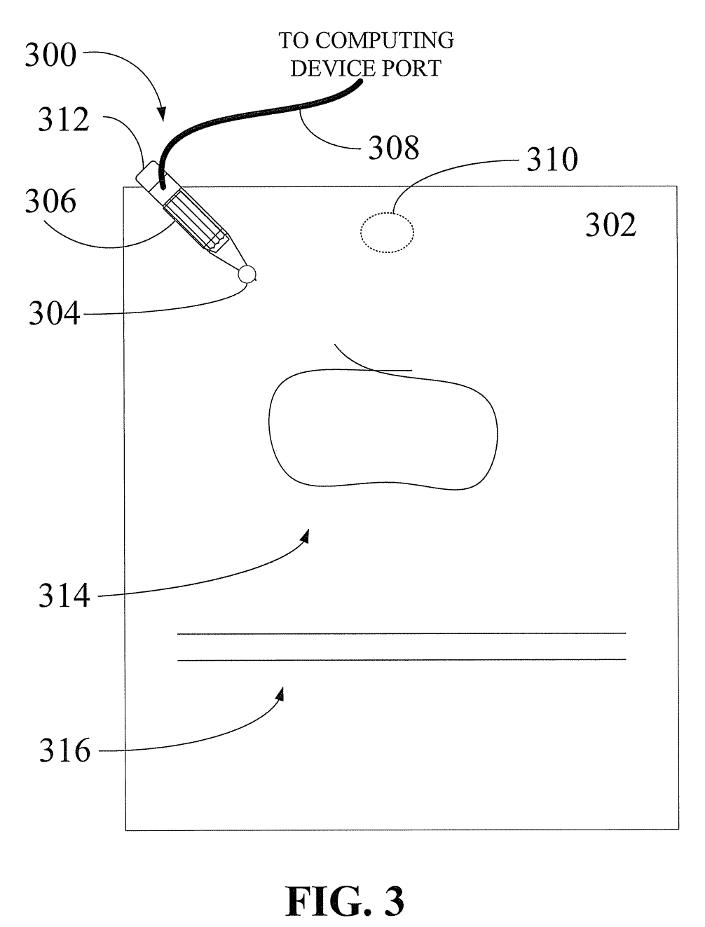

As noted above, the processing file 116 can comprise stored computer-readable instructions for causing the processor 104 of the computing device 102 to add user-supplied notes or annotations, which can be stored in a memory of the computing device 102 or in the RAM of a handheld electronic memory device 110. FIG. 3 schematically illustrates an apparatus 300 for enabling a user to work directly with a physical medium containing printed information, such as a page 302 of text from a book, according to yet another aspect of the invention. The apparatus 300 illustratively has the form factor of a pencil or stylus. According to one embodiment, a ball 304 is positioned at a tip of the apparatus 300. The ball 304 rotates as the user moves the apparatus 300 while touching the page 302. Within a housing 306, two rollers (not shown) are positioned to roll against two sides of the ball as it rotates, one roller detecting horizontal movements of the apparatus and the other the detecting vertical movements. The motion of the rollers causes encoder wheels (not shown) to rotate, interrupting optical beams generated, for example, by light-emitting diodes (not shown) positioned within the housing 306. Electrical signals are generated by the intermitted interruptions of light, and the resulting signals are conveyed via a cable 308 to the processor 104 of the computing device.

In accordance with this embodiment, the processing file 116 includes stored computer-readable instructions for causing the processor 104 to convert the electrical signals into detected movements of the apparatus 300 along the vertical and horizontal axes of the page 302. Moreover, according to this embodiment, the information file 114 further comprises dimensions of each page of text. The user can input the particular page of text, using for example a keyboard (not shown) connected to the computing device 102, if the object containing printed information is a book or other multi-page object. The stored computer-readable instructions cause the processor 104 to correlate the detected movement of the apparatus over the physical page 302 with the stored dimensions so as to locate the position of the apparatus relative to the page and to track the movement of the apparatus over the page. By initially touching a designated point or region 310 on the page 302 with the apparatus, a reference point is established for correlating the detected movements with the actual layout of the page. By depressing a button 312 on the apparatus 300, the user can signal that movement of the apparatus is intended to add a circle 314 around a portion of text, add underlines 316 to lines of text, highlight text, and/or annotate the text with written notes, for example. As already described, the markups effected using the apparatus 300 can then be stored either in a memory of the computing device 102 or within a handheld electronic memory device 110, 210.

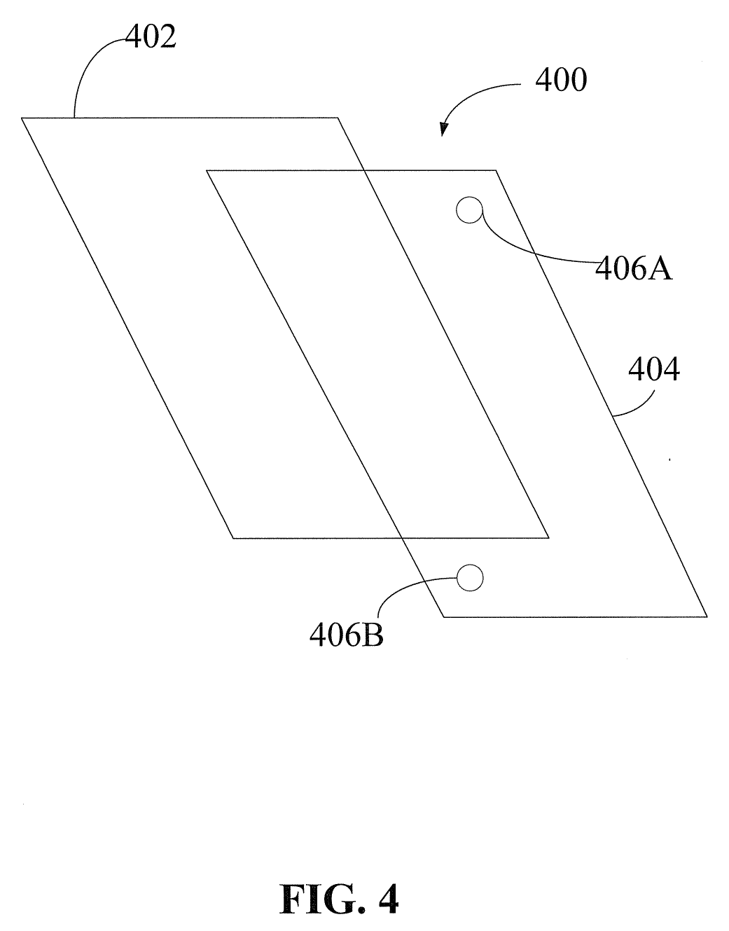

FIG. 4 is a schematic view of an alternative apparatus 400 for enabling a user to work directly with a physical medium containing printed information, such as a page 402 of text from a book. The apparatus 400 comprises a transparent overlay 404 that can be positioned on or over the page 402 or other physical medium containing printed information. The apparatus 400 further comprises a pair of transducers 406A, 406B, one of which receives a signal and the other of which transmits a signal, and a plurality of reflectors (not shown) positioned on the overlay 404. Operatively, the reflectors reflect an electrical signal transmitted from the one transducer to the other. The receiving transducer responds to a user touching the overly 404 directly or with a stylus or other such device. The resulting signals are transmitted to the computing device 102 for processing with the processor 104.

Again, the processing file 116 includes stored computer-readable instructions for causing the processor 104 to convert the signals into detected movements of the apparatus 300 along the vertical and horizontal axes of the page 402. The information file 114 comprises dimensions of each page of text. Using, for example, a keyboard (not shown) connected to the computing device 102, the user can a particular page of text if the object containing printed information is a book or other multi-page object. The stored computer-readable instructions cause the processor 104 to correlate detected contact with the overlay 404, which is aligned over the physical page 402 and whose dimensions are predetermined, with the stored dimensions of the particular page 402, thereby locating the position of contact on the overly 404 and matching that to a corresponding location on the physical page 402 beneath the overlay 404. The user can touch the overlay directly or with a stylus to add a circle around a portion of text, add underlines to lines of text, highlight text, and/or annotate the text with written notes, for example. The markups effected using the apparatus 400, again, can then be stored either in a memory of the computing device 102 or within a handheld electronic memory device 110, 210.

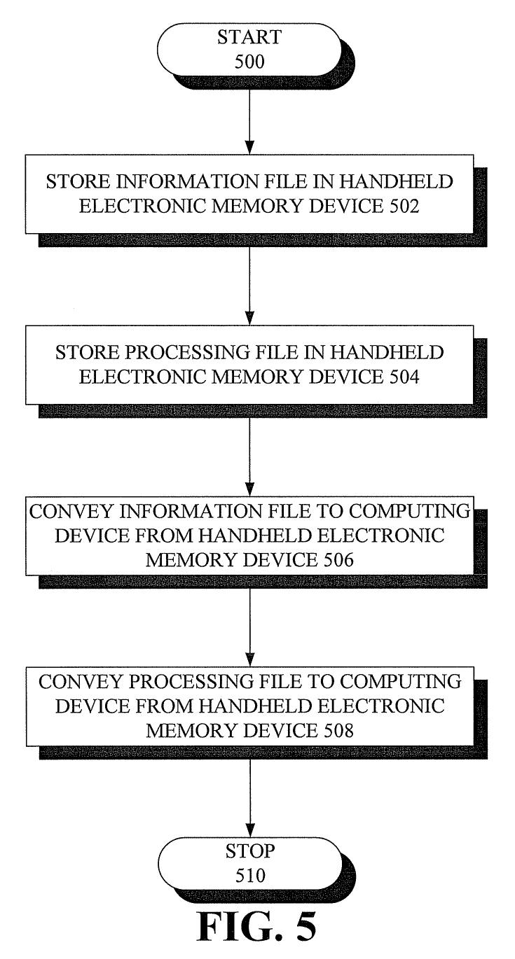

FIG. 5 is a flowchart of exemplary steps in a method 500 for merging electronic and printed information, according to another aspect of the invention. The method includes, at step 502, storing in a handheld electronic memory device one or more information files comprising information identical to printed information appearing on a physical medium. The method also includes storing a processing file in the handheld electronic memory device at step 504, the processing file comprising stored computer-readable instructions for allowing a user to read the printed information on the physical medium while electronically manipulating the same information stored electronically.

Additionally, the method includes conveying from the handheld electronic memory device to a computing device having a visual display the at least one information file at step 506. The method further includes, at step 508, conveying from the handheld electronic memory device to a computing device the processing file. According to the method, both the information file and the processing file are conveyed to the computing device through an electrical connector attached to the handheld electronic memory and connected to the computing device. The method illustratively concludes at step 510.

According to a particular embodiment, the method 500 can be effected by executing computer-readable instructions, the instructions being contained in the process file and for causing the computer to perform the various steps. The computer-readable instructions, more particularly, can be contained in a physical medium or computer product that stores computer-readable data and/or instructions.

The invention, as already noted, can be realized in hardware, software, or a combination of hardware and software. The invention can be realized in a centralized fashion in one computer module, or in a distributed fashion where different elements are spread across several interconnected computer modules. Any kind of computer module or other apparatus adapted for carrying out the methods described herein is suited. A typical combination of hardware and software can be a general purpose computer module with a computer program that, when being loaded and executed, controls the computer module such that it carries out the methods described herein.

The invention, as also already noted, can be embedded in a computer program product, which comprises all the features enabling the implementation of the methods described herein, and which when loaded in a computer module is able to carry out these methods. Computer program in the present context means any expression, in any language, code or notation, of a set of instructions intended to cause a module having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A system for merging electronic and printed information, the system comprising:
a computing device having a visual display;
a handheld electronic memory device containing at least one information file comprising information corresponding to printed information appearing on a physical medium, and containing a processing file comprising stored computer-readable instructions; and
an electrical connector attached to the handheld electronic memory device for connecting to the computing device having the visual display, wherein the at least one information file and the processing file are conveyed via the electrical connector to the computing device when the electrical connector is connected to the computing device.

2. The system of claim 1, wherein the processing file comprises stored computer-readable instructions for causing the processor of the computing device to search the information file for and to display on the visual display user-selected portions of the printed information in response to user-supplied input to the processor of the computing device.

3. The system of claim 1, wherein the processing file comprises stored computer-readable instructions for causing the processor of the computing device to convey update information to the handheld electronic memory device via the electrical connector and to store the update information in the handheld electronic memory device as part of the information file.

4. The system of claim 1, wherein the processing file comprises stored computer-readable instructions for causing the processor of the computing device to display an identifier on the visual display and to access via a data communications network at least one remotely located computing device in response to a user selecting the identifier.

5. The system of claim 4, wherein the at least one remotely-located computing device is operated by a sponsor of the printed information, and wherein the processing file comprises stored computer-readable instructions for causing the computing device to receive from the at least one remotely-located computing device through the data communications network at least one request for user information.

6. The system of claim 5, wherein the processing file comprises stored computer-readable instructions for causing the processor of the computing device to convey via the data communications network to the at least one remotely-located computing device at least one user response to the at least one request.

7. The system of claim 1, wherein the information file further comprises supplemental information corresponding to the printed information.

8. The system of claim 1, wherein the handheld electronic memory device and the electrical connector comprise a detachable unit configured to connect to an object containing the printed information and to connect to the computing device when detached from the object.

9. The system of claim 1, wherein the handheld electronic memory device and the electrical connector comprise a unit embedded in the object containing the printed information, and wherein the connector extends from the object to connect to the computing device.

10. The system of claim 1, further comprising a handheld stylus for generating marking information as it is moved by a user over the physical medium and conveying the marking information to the computing device, and wherein the processing file comprises stored computer-readable instructions for causing the processor to change the information contained in the information file based upon the marking information.

11. A module for merging electronic and printed information, the module comprising:
a handheld electronic memory device containing at least one information file comprising information corresponding to printed information appearing on a physical medium, and containing a processing file comprising stored computer-readable instructions; and
an electrical connector attached to the handheld electronic memory device for connecting to a computing device having a visual display, wherein the at least one information file and the processing file are conveyed via the electrical connector to a computing device when the electrical connector is connected to the computing device.

12. The module of claim 11, wherein the processing file comprises stored computer-readable instructions for causing the processor of the computing device to search the information file and to display on the visual display user-selected portions of the printed information in response to user-supplied input to the computing device.

13. The module of claim 10, wherein the processing file comprises stored computer-readable instructions for causing the processor of the computing device to convey to the handheld electronic memory device via the electrical connector update information and to store the update information in the information file.

14. The module of claim 10, wherein the processing file comprises stored computer-readable instructions for causing the computing device to access via a data communications network at least one remotely located computing device in response to a user selecting an identifier appearing on the visual display.

15. The module of claim 14, wherein the at least one remotely-located computing device is operated by a sponsor of the printed information, and wherein the processing file is further configured to cause the computing device to receive from the at least one remotely-located computing device through the data communications network at least one request for user information.

16. The module of claim 15, wherein the processing file comprises stored computer-readable instructions for causing the processor of the computing device to convey via the data communications network to the at least one remotely-located computing device at least one user response to the at least one request.

17. The module of claim 10, wherein the information file further comprises supplemental information corresponding to the printed information.

18. The module of claim 10, wherein the handheld electronic memory device and the electrical connector comprise a detachable unit configured to connect to an object containing the printed information and to connect to the computing device when detached from the object.

19. The module of claim 10, wherein the handheld electronic memory device and the electrical connector comprise a unit embedded in an object containing the printed information, and wherein the connector extends from the object to connect to the computing device.

20. A method for merging electronic and printed information, the method comprising:
storing in a handheld electronic memory device at least one information file comprising information corresponding to printed information appearing on a physical medium, and a processing file comprising stored computer-readable instructions for performing at least one of searching for a user-specified portion of information contained in the at least one information file, updating information contained in the at least one information file in response to a user specification, and supplementing or replacing information contained in the at least one information file; and
conveying from the handheld electronic memory device to a computing device having a visual display the at least one information file and the processing file via an electrical connector attached to the handheld electronic memory and connected to the computing device.
